(19) United States
(12) Patent Application Publication
(10) Pub. No.: US 2002/0140637 A1
(43) Pub. Date: Oct. 3, 2002

(54) Method for prolonging useful life of plasma panel display by dynamically adjusting input video signal strength

(76) Inventors: Shiuh-Bin Kao, Taipei (TW); Chien-Pang Lee, Taipei (TW); Kuang-Lang Chen, Taipei (TW); Sheng-Chi Lee, Taipei (TW)

Correspondence Address: BACON & THOMAS, PLLC, 625 SLATERS LANE, FOURTH FLOOR, ALEXANDRIA, VA, 22314

(21) Appl. No.: 09/859,399

(22) Filed: May 18, 2001

(30) Foreign Application Priority Data
Apr. 3, 2001 (TW) 090108029

(51) Int. Cl. G09G 3/28

(52) U.S. Cl. 345/60

(57) ABSTRACT

In a plasma display panel (PDP) a method for prolonging useful life thereof comprises the steps of performing an experiment on red, green, and blue phosphor layers each coated on a corresponding discharge cell for calculating a gain per gray scale on the phosphor layer of each discharge cell and obtaining expressions to represent relationship with respect to the use time of each discharge cell, thereby establishing a comparison table with respect to the gains; enabling a control circuit of PDP to select one of the gains from the comparison table based on use time for dynamically adjusting strength of input video signal of each discharge cell; and compensating a reduced brightness per gray scale on the phosphor layer of each discharge cell due to increase of the use time by each of emitted red, green and blue lights. This compensates the reduced emissivity and eliminates adverse effects such as shortening of life, color temperature change, and color deviation caused by the reduced emissivity. As a result, an image having an optimum color purity and color temperature is rendered and accordingly the useful life of PDP is improved.

### FIELD OF THE INVENTION

The present invention relates to plasma display panels (PDPs) and more particularly to a method for prolonging useful life of PDP by dynamically adjusting input video signal strength.

### BACKGROUND OF THE INVENTION

A manufacturing process of a conventional alternating current discharge type plasma display panel (PDP) 10 is shown in FIG. 2. First, two different activation layers are formed on glass substrates 11 and 12 respectively. Then seal the peripheries of the glass substrates together. A mixed gas consisting of helium (He), neon (Ne), and xenon (Xe) (or argon (Ar)) having a predetermined mixing volume ratio is stored in a discharge space formed in between the glass substrates. A front plate 11 is defined as one that facing viewers. A plurality of parallel spaced transparent electrodes 111, a plurality of parallel spaced bus electrodes 112, a dielectric layer 113, and a protective layer 114 are formed from the front plate 11 inwardly. From a corresponding rear plate 12 inwardly, a plurality of parallel spaced data electrodes 121, a dielectric layer 124, a plurality of parallel spaced ribs 122, and a uniform phosphor layer 123 are formed. When a voltage is applied on electrodes 111, 112, and 121, dielectric layers 113 and 124 will discharge in discharge cell 13 formed by adjacent spaced ribs 122. As a result, a ray having a desired color is emitted from phosphor layer 123.

Conventionally, in PDP 10 a plurality of parallel spaced transparent electrodes 111 are formed on inner surface of front plate 11 by sputtering and photolithography (or printing). Then a plurality of parallel spaced bus electrodes 112 are formed on the transparent electrodes 111 respectively by plating (or sputtering) and photolithography. The line impedance of the transparent electrodes 111 may be reduced by the provision of bus electrodes 112. In the following description, two adjacent transparent electrodes 111 (including bus electrodes 112) on the front plate 11 are represented by X electrode and Y electrode respectively. A triple electrode is formed by X electrode, Y electrode and corresponding data electrode 121 on the rear plate 12. When a voltage is applied on the triple electrode, dielectric layers 113 and 124 will discharge in discharge cell 13 formed by adjacent spaced ribs 122. Hence, UV rays are emitted from the mixed gas stored therein. And in turn, phosphor layer 123 in discharge cell 13 is activated by the UV rays. As an end, a visible light is generated by red, green and blue phosphor layers, resulting in an image showing.

However, in a conventional plasma display panel (PDP) 10 as shown in FIG. 2, the emissivity of a phosphor layer 123 consisting of red, green, and blue lights is a function of time. In other words, the emissivity of phosphor layer 123 is lowered as use time increases. The degree of lowering is depending on the feature (e.g., material) of phosphor layer 123. However, such drop will inevitably shorten the useful time of PDP 10 and accordingly cause color temperature change (i.e., lowering) and color deviation therein. As to above color temperature lowering, color deviation, and poor image quality occurred on the conventional PDP 10, until now no effective solution has been proposed by the PDP manufacturers. Thus, it is desirable to provide a novel method for prolonging useful life of PDP in order to overcome the above drawbacks of prior art.

### SUMMARY OF THE INVENTION

It is thus an object of the present invention to provide a method for prolonging useful life of plasma panel display (PDP) comprising the steps of performing an experiment on red, green, and blue phosphor layers each coated on a corresponding discharge cell for calculating a gain per gray scale on the phosphor layer of each discharge cell and obtaining expressions to represent relationship with respect to the use time of each discharge cell, thereby establishing a comparison table with respect to the gains; enabling a control circuit of PDP to select one of the gains from the comparison table based on use time for dynamically adjusting strength of input video signal of each discharge cell; and compensating a reduced brightness per gray scale on the phosphor layer of each discharge cell due to increase of the use time by each of emitted red, green and blue lights. This compensates the reduced emissivity and eliminates adverse effects such as shortening of life, color temperature change, and color deviation caused by the reduced emissivity. As a result, an image having an optimum color purity and color temperature is rendered and accordingly the useful life of PDP is improved.

The above and other objects, features and advantages of the present invention will become apparent from the following detailed description taken with the accompanying drawings.

### BRIEF DESCRIPTION OF THE DRAWINGS

FIG. 1 is a flow chart illustrating the method for prolonging useful life of a PDP according to the invention; and

FIG. 2 is a cross-sectional view of a conventional PDP.

### DETAILED DESCRIPTION OF THE PREFERRED EMBODIMENTS

Typically, an image shown on a well known PDP consists of a plurality of pixels. Further, the number of pixels is determined by the resolution of PDP. A pixel consists of three discharge cells capable of emitting red, green, and blue lights respectively. As such, color of pixel of image shown on PDP is simply a combination of red, green and blue lights emitted by respective discharge cell. For example, a, b, and c are gray scales of red, green and blue lights emitted by respective discharge cell of each pixel of PDP. Also, Rₚ, Gₚ, and Bₚ are brightness emitted by unit gray scale of phosphor layer in red, green and blue discharge cells of each pixel. Hence, brightness of red, green, and blue discharge cells may be expressed by equations 1, 2 and 3 below:

brightness of red discharge cell=aRₚ (1);

brightness of green discharge cell=bGₚ (2);

and

brightness of blue discharge cell=cBₚ (3)

Also, brightness of pixel may be expressed by the following equation 4:

brightness of pixel=brightness of red discharge cell+brightness of green discharge cell+brightness of blue discharge cell=aRₚ+bGₚ+cBₚ (4)

Further, ratio among brightness of red, green and blue discharge cells may be expressed by the following equation 5:

brightness of red discharge cell:brightness of green discharge cell:brightness of blue discharge cell=aRₚ:bGₚ:cBₚ (5)

As stated above, emissivity of phosphor layer of PDP is lowered as use time increases. The reduced brightness per gray scale of each of red, green, and blue discharge cells of PDP due to use time increase is represented by k_{R}Rₚ, k_{G}Gₚ, and k_{B}Bₚ respectively where k_{R}<1, k_{G}<1, and k_{B}<1. Hence, after a long time of use brightness of each of red, green, and blue discharge cells, and pixel may be expressed in the following equations 6, 7, 8, and 9 respectively:

brightness of red discharge cell=ak_{R}Rₚ (6);

brightness of green discharge cell=bk_{G}Gₚ (7);

brightness of blue discharge cell=ck_{B}Bₚ (8);

and

brightness of pixel=brightness of red discharge cell+brightness of green discharge cell+brightness of blue discharge cell=ak_{R}Rₚ+bk_{G}Gₚ+ck_{B}Bₚ (9)

Further, ratio among brightness of red, green and blue discharge cells may be expressed by the following equation 10:

brightness of red discharge cell:brightness of green discharge cell:brightness of blue discharge cell=ak_{R}Rₚ:bk_{G}Gₚ:ck_{B}Bₚ (10)

In comparison of equations 5 and 10, it is found that ratio among brightness of red, green and blue discharge cells is changed which in turn causes color deviation. It is also found that the degree of brightness lowering of blue discharge cell is the largest among all discharge cells, resulting in a decrease of color temperature of PDP.

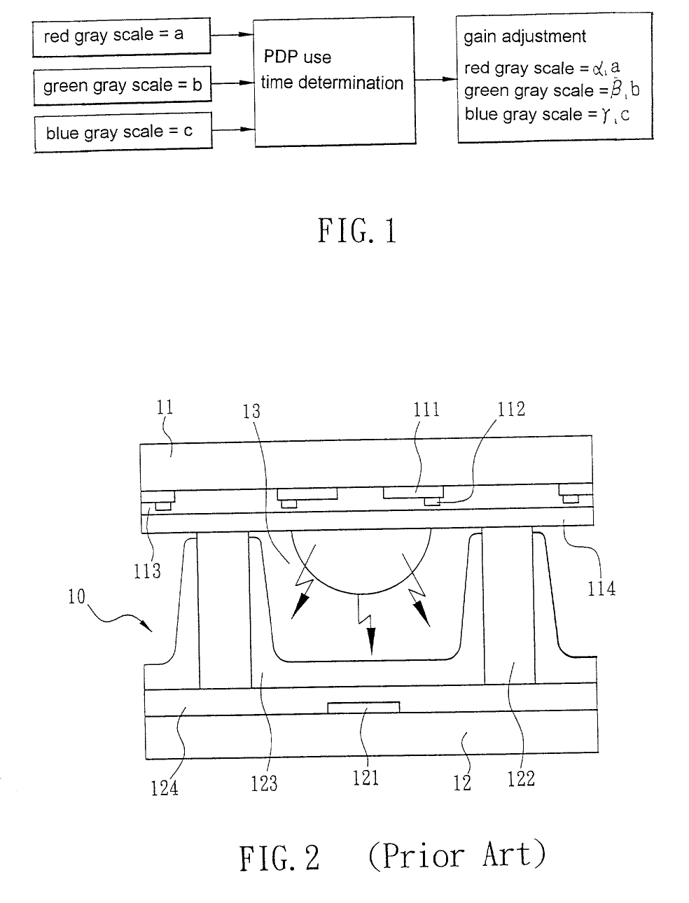

One aspect of the invention is to improve the reduced emissivity per gray scale of each discharge cell due to the increase of use time and eliminate adverse effects such as color temperature change and color deviation of PDP caused by such increase of use time. Hence, red, green and blue phosphor layers coated on the corresponding discharge cell are used in an experiment as detailed in the flow chart of FIG. 1. Firstly, analyze the reduced emissivity per gray scale on phosphor layer of each discharge cell due to increase of use time of PDP. Then a temperature function is used to calculate gain (e.g., αᵢ, βᵢ, or γᵢ) per gray scale on each of red, green, and blue phosphor layers of discharge cells and obtain expressions to represent their relationship with respect to use time of each discharge cell as below:

tᵢ<T<t_{i+1 →}αᵢ

tᵢ<T<t_{i+1 →}βᵢ

tᵢ<T<t_{i+1 →}γᵢ

where tᵢ and tᵢ₊₁ are upper and lower limits of respective period of time and T is use time. Hence, a comparison table is established by referencing above data. Hence, a control circuit of PDP may be enabled to select one of gains αᵢ, βᵢ, and γᵢ from the comparison table based on use time T for dynamically adjusting input video signal strength of respective discharge cell. Then each of red, green and blue lights is emitted from the respective discharge cell. Such lights in turn are used to compensate (i.e., increase) the reduced emissivity per gray scale of each discharge cell due to increase of use time and eliminate the adverse effects such as shortening of useful life, color temperature change and color deviation of PDP caused by such reduced emissivity. As a result, an image having an optimum color purity and color temperature is rendered. Most importantly, the useful life of a conventional PDP is greatly improved by implementing the method of the invention.

In one embodiment of the invention, a technique has been proposed to solve above reduced brightness of each discharge cell of PDP due to increase of use time. In detail, after a predetermined use time, the control circuit of PDP is enabled to select one of gains αᵢ, βᵢ, and γᵢ from the comparison table based on use time T for dynamically adjusting input video signal strength of respective discharge cell. As a result, red, green and blue lights emitted from discharge cells are changed. Such changed lights in turn are used to compensate (i.e., increase) the reduced emissivity per gray scale of each discharge cell due to increase of use time. Ratio among the compensated gains αᵢ, βᵢ, γᵢ may be expressed in the following equations (11) and (12):

αᵢ:βᵢ:γᵢ=k_{G}k_{B}:k_{R}k_{B}:k_{R}k_{G} (11)

max{αᵢ, βᵢ, γᵢ)≦1 (12)

Also, brightness of each of red, green, and blue discharge cells, and pixel after compensation may be expressed in the following equations 13, 14, 15, and 16 respectively:

brightness of red discharge cell after compensation=(ak_{R}αᵢ)R_{P} (13);

brightness of green discharge cell after compensation=(bk_{G}βᵢ)G_{P} (14);

brightness of blue discharge cell after compensation=(ck_{B}γᵢ)B_{P} (15);

and

brightness of pixel after compensation=brightness of red discharge cell after compensation+brightness of green discharge cell after compensation+brightness of blue discharge cell after compensation=(ak_{R}αᵢ)R_{P}+(bk_{G}βᵢ)G_{P}+(ck_{B}γᵢ)B_{P} (16)

In view of above equations 11 to 16, after compensation ratio among brightness of red, green and blue discharge cells may be expressed by the following equation 17:

brightness of red discharge cell after compensation:brightness of green discharge cell after compensation:brightness of blue discharge cell after compensation=(ak_{R}αᵢ)R_{P}:(bk_{G}βᵢ)G_{P}:(ck_{B}γᵢ)B_{P}=aR_{P}:bG_{P}:cB_{P} (17)

In comparison of equations 17 and 5, it is found that above ratio among brightness of red, green and blue discharge cells has returned to a true ratio, resulting in a total elimination of the adverse effects caused by the reduced emissivity of phosphor layer.

In another embodiment of the invention, a technique has been proposed to solve above reduced brightness per gray scale of each of red, green and blue discharge cells of PDP due to increase of use time. In detail, brightness of each of red, green, and blue discharge cells, and pixel may be expressed in the following equations 18, 19, 20, and 21 respectively:

brightness of red discharge cell=a(R_{P}−T_{R}) (18);

brightness of green discharge cell=b(G_{P}−T_{G}) (19);

brightness of blue discharge cell=c(B_{P}−T_{B}) (20);

and

brightness of pixel=brightness of red discharge cell+brightness of green discharge cell+brightness of blue discharge cell=aR_{P}+bG_{P}+cB_{P}−aT_{R}−bT_{G}−cT_{B} (21);

where aT_{R}, bT_{G}, and cT_{B} are reduced brightness of each of red, green, and blue discharge cells due to increase of use time. Such reduced brightness may also cause adverse effects such as shortening of useful life, color temperature change and color deviation of PDP. One characteristics of the invention is to improve the reduced emissivity per gray scale of each discharge cell due to increase of use time and eliminate the adverse effects such as color temperature change and color deviation of PDP caused by such increase of use time. Hence, red, green and blue phosphor layers coated on the corresponding discharge cells are used in an experiment as detailed in the flow chart of FIG. 1. Firstly, analyze the reduced emissivity per gray scale on phosphor layer of each discharge cell due to increase of use time of PDP. Then a temperature function is used to calculate reduced brightness (e.g., T_{Ri}, T_{Gi}, and T_{Bi}) per gray scale on each of red, green, and blue phosphor layers of discharge cells and obtain expressions to represent their relationship with respect to use time of each discharge cell as below:

tᵢ<T<tᵢ₊₁ →T_{Ri}

ti<T<tᵢ₊₁ →T_{Gi}

ti<T<tᵢ₊₁ →T_{Bi}

where tᵢ and tᵢ₊₁ are upper and lower limits of respective period of time and T is use time. Hence, a comparison table is established by referencing above data. Also, a control circuit of PDP may be enabled to select one of T_{Ri}, T_{Gi}, and T_{Bi} from the comparison table based on use time T for dynamically adjusting input video signal strength of respective discharge cell. Then each of red, green and blue lights is emitted from the respective discharge cell. Such lights in turn are used to compensate (i.e., increase) the reduced emissivity per gray scale of each discharge cell due to increase of use time and eliminate the adverse effects such as shortening of useful life, color temperature change and color deviation of PDP caused by such reduced emissivity. As a result, an image having an optimum color purity and color temperature is rendered. Most importantly, the useful life of a conventional PDP is greatly improved by implementing the method of the invention.

Any of above embodiments of the invention is provided for solving the reduced brightness of each discharge cell of PDP due to increase of use time. After a predetermined use time, the control circuit of PDP is enabled to select one of T_{Ri}, T_{Gi}, and T_{Bi} from the comparison table based on use time T for increasing input video signal strength of respective discharge cell. As a result, red, green and blue lights emitted from discharge cells are increased. Such increase in turn are used to compensate (i.e., increase) the reduced emissivity per gray scale of each discharge cell due to increase of use time.

Moreover, based on result of experiment reduced brightness per gray scale on respective discharge cell due to increase of use time such as T_{Ri}, T_{Gi}, and T_{Bi} may be expressed in the following equations 22, 23, and 24:

T_{Ri}=k_{Ri}R_{P} (22);

T_{Gi}=k_{Gi}G_{P} (23),

and

T_{Bi}=k_{Bi}B_{P} (24);

where k_{Ri}, k_{Gi} and k_{Bi} are brightness compensation coefficients obtained by experiments. Further, ak_{Ri}, bk_{Gi}, and ck_{Bi} are increased brightness on red, green, and blue discharge cells respectively. Thus, brightness of compensated discharge cells and pixel may be expressed in the following equations 24, 25, 26 and 27 respectively:

brightness of red discharge cell after compensation=a(1+k_{Ri})R_{P}−aT_{Ri} (24);

brightness of green discharge cell after compensation=b(1+k_{Gi})G_{P}−bT_{Gi} (25);

brightness of blue discharge cell after compensation=c(1+k_{Bi})B_{P}−cT_{Bi} (26);

and

brightness of pixel after compensation=brightness of red discharge cell after compensation+brightness of green discharge cell after compensation+brightness of blue discharge cell after compensation=aR_{P}+bG_{P}+cB_{P} (27)

In brief, the method of the invention can compensate (i.e., increase) the reduced emissivity per gray scale of each discharge cell due to increase of use time and eliminate adverse effects such as color temperature change and color deviation of PDP caused by such increase of use time by dynamically adjusting input video signal strength. As a result, an image having an optimum color purity and color temperature is rendered. Most importantly, the useful life of a conventional PDP is greatly improved.

While the invention has been described by means of specific embodiments, numerous modifications and variations could be made thereto by those skilled in the art without departing from the scope and spirit of the invention set forth in the claims.

What is claimed is:

1. In a plasma display panel (PDP) a method for prolonging useful life thereof comprising the steps of:
(a) after a predetermined use time dynamically adjusting strength of an input video signal of each of red, green and blue discharge cells of said PDP;
(b) emitting red, green and blue lights from said red, green and blue discharge cells respectively; and
(c) utilizing said emitted red, green and blue lights to compensate a reduced emissivity per gray scale on a phosphor layer of each discharge cell due to increase of said use time.

2. The method of claim 1, wherein in said step (c) further comprises the sub-steps of:
(c1) performing an experiment on said red, green, and blue phosphor layers each coated on said corresponding discharge cell for calculating a gain per gray scale on said phosphor layer of each discharge cell and obtaining expressions to represent relationship with respect to said use time of each discharge cell, thereby establishing a comparison table with respect to said gains;
(c2) enabling a control circuit of said PDP to select one of said gains from said comparison table based on said use time for dynamically adjusting strength of said input video signal of each of said discharge cells; and
(c3) compensating said reduced brightness per gray scale on said phosphor layer of each of said discharge cells due to increase of said use time by each of said emitted red, green and blue lights.

3. The method of claim 1 or 2, wherein said gain per gray scale on said phosphor layer of each discharge cell is a time depending value.

4. The method of claim 1 or 2, wherein said gain per gray scale on said phosphor layer of each discharge cell is a value depending on said use time and a material forming said phosphor layer.
